(19) United States
(12) Patent Application Publication
(10) Pub. No.: US 2026/0065125 A1
(43) Pub. Date: Mar. 5, 2026

(54) REDUCED TRAINING SETS FOR TRAINING CLASSIFIERS OR OTHER ARTIFICIAL INTELLIGENCE/MACHINE LEARNING (AI/ML) MODELS

(71) Applicant: Raytheon Company, Tewksbury, MA (US)

(72) Inventor: Tadd B. Hughes, Andover, MA (US)

(21) Appl. No.: 18/816,864

(22) Filed: Aug. 27, 2024

(51) Int. Cl. G06N 20/00

(52) U.S. Cl. CPC G06N 20/00

(57) ABSTRACT

A method includes obtaining observation information related to an artificial intelligence/machine learning (AI/ML) model to be trained and identifying multiple variables associated with the observation information. The method also includes analyzing at least a portion of the observation information associated with the identified variables to determine whether the identified variables are redundant and determining that two or more of the identified variables are redundant with one another based on the analysis. The method further includes obtaining a set of training data for training the AI/ML model, where the set of training data includes observations over a range of values for at least one of the two or more variables determined to be redundant and lacks observations over a range of values for at least one other of the two or more variables determined to be redundant.

### GOVERNMENT RIGHTS

This invention was made with U.S. government support. The government has certain rights in the invention.

### TECHNICAL FIELD

This disclosure relates generally to artificial intelligence/machine learning (AI/ML) systems and processes. More specifically, this disclosure relates to reduced training sets for training classifiers or other AI/ML models.

### BACKGROUND

Modern artificial intelligence/machine learning (AI/ML) models can contain large numbers of parameters, and training modern AI/ML models may require large amounts of training data. For example, some current large language models (LLMs) include more than 175 billion parameters, and these large language models can be trained using training datasets with more than 400 billion tokens. The complexity of AI/ML models will continue to increase over time, and the amount of training data needed for training these AI/ML models will also continue to increase over time.

### SUMMARY

This disclosure relates to reduced training sets for training classifiers or other artificial intelligence/machine learning (AI/ML) models.

In a first embodiment, a method includes obtaining observation information related to an AI/ML model to be trained and identifying multiple variables associated with the observation information. The method also includes analyzing at least a portion of the observation information associated with the identified variables to determine whether the identified variables are redundant and determining that two or more of the identified variables are redundant with one another based on the analysis. The method further includes obtaining a set of training data for training the AI/ML model, where the set of training data includes observations over a range of values for at least one of the two or more variables determined to be redundant and lacks observations over a range of values for at least one other of the two or more variables determined to be redundant.

Any single one or any combination of the following features may be used with the first embodiment. Analyzing at least the portion of the observation information to determine whether the identified variables are redundant may include performing a two-sample Kolmogorov-Smirnov test to determine whether the identified variables are redundant. Determining that the two or more variables are redundant with one another may include determining that a Kolmogorov-Smirnov statistic generated during the two-sample Kolmogorov-Smirnov test does not meet or exceed a threshold value. Analyzing at least the portion of the observation information to determine whether the identified variables are redundant may include generating a first vector containing first feature values of a single feature of the observation information, where the first feature values are a function of a first variable of the multiple variables while a second variable of the multiple variables has a first fixed value. Analyzing at least the portion of the observation information to determine whether the identified variables are redundant may include generating a second vector containing second feature values of the single feature of the observation information, where the second feature values are a function of the first variable while the second variable has a second fixed value. Analyzing at least the portion of the observation information to determine whether the identified variables are redundant may include using the first and second vectors to determine whether the first and second variables are redundant. Analyzing at least the portion of the observation information to determine whether the identified variables are redundant may include determining whether (i) observations based on a range of values for a first variable and a second variable fixed to a first value and (ii) observations based on the range of values for the first variable and the second variable fixed to a second value come from a common probability distribution. The method may include training the AI/ML model using the set of training data. The AI/ML model may include a classifier that is trained to classify input data into different classes. The set of training data may include observations over a range of values for at least one of the classes and lacks observations over a range of values for at least one other of the classes. The method may include deploying the trained AI/ML model and/or using the trained AI/ML model to process input data and perform inferencing.

In a second embodiment, an apparatus includes at least one processing device configured to obtain observation information related to an AI/ML model to be trained and identify multiple variables associated with the observation information. The at least one processing device is also configured to analyze at least a portion of the observation information associated with the identified variables to determine whether the identified variables are redundant and determine that two or more of the identified variables are redundant with one another based on the analysis. The at least one processing device is further configured to obtain a set of training data for training the AI/ML model, where the set of training data includes observations over a range of values for at least one of the two or more variables determined to be redundant and lacks observations over a range of values for at least one other of the two or more variables determined to be redundant.

Any single one or any combination of the following features may be used with the second embodiment. The at least one processing device may be configured to perform a two-sample Kolmogorov-Smirnov test to determine whether the identified variables are redundant. The at least one processing device may be configured to determine that a Kolmogorov-Smirnov statistic generated during the two-sample Kolmogorov-Smirnov test does not meet or exceed a threshold value to determine that the two or more variables are redundant with one another. To analyze at least the portion of the observation information to determine whether the identified variables are redundant, the at least one processing device may configured to generate a first vector containing first feature values of a single feature of the observation information, where the first feature values are a function of a first variable of the multiple variables while a second variable of the multiple variables has a first fixed value. To analyze at least the portion of the observation information to determine whether the identified variables are redundant, the at least one processing device may configured to generate a second vector containing second feature values of the single feature of the observation information, where the second feature values are a function of the first variable while the second variable has a second fixed value. To analyze at least the portion of the observation information to determine whether the identified variables are redundant, the at least one processing device may configured to use the first and second vectors to determine whether the first and second variables are redundant. To analyze at least the portion of the observation information to determine whether the identified variables are redundant, the at least one processing device may be configured to determine whether (i) observations based on a range of values for a first variable and a second variable fixed to a first value and (ii) observations based on the range of values for the first variable and the second variable fixed to a second value come from a common probability distribution. The at least one processing device may be configured to train the AI/ML model using the set of training data. The AI/ML model may include a classifier that is trained to classify input data into different classes. The set of training data may include observations over a range of values for at least one of the classes and lacks observations over a range of values for at least one other of the classes. The at least one processing device may be configured to deploy the trained AI/ML model and/or use the trained AI/ML model to process input data and perform inferencing.

In a third embodiment, a non-transitory machine readable medium contains instructions that when executed cause at least one processor to obtain observation information related to an AI/ML model to be trained and identify multiple variables associated with the observation information. The non-transitory machine readable medium also contains instructions that when executed cause the at least one processor to analyze at least a portion of the observation information associated with the identified variables to determine whether the identified variables are redundant and determine that two or more of the identified variables are redundant with one another based on the analysis. The non-transitory machine readable medium further contains instructions that when executed cause the at least one processor to obtain a set of training data for training the AI/ML model, where the set of training data includes observations over a range of values for at least one of the two or more variables determined to be redundant and lacks observations over a range of values for at least one other of the two or more variables determined to be redundant.

Any single one or any combination of the following features may be used with the third embodiment. The instructions that when executed cause the at least one processor to analyze at least the portion of the observation information to determine whether the identified variables are redundant may include instructions that when executed cause the at least one processor to perform a two-sample Kolmogorov-Smirnov test to determine whether the identified variables are redundant. The instructions that when executed cause the at least one processor to determine that the two or more variables are redundant with one another may include instructions that when executed cause the at least one processor to determine that a Kolmogorov-Smirnov statistic generated during the two-sample Kolmogorov-Smirnov test does not meet or exceed a threshold value. The instructions that when executed cause the at least one processor to analyze at least the portion of the observation information to determine whether the identified variables are redundant may include instructions that when executed cause the at least one processor to generate a first vector containing first feature values of a single feature of the observation information, where the first feature values are a function of a first variable of the multiple variables while a second variable of the multiple variables has a first fixed value. The instructions that when executed cause the at least one processor to analyze at least the portion of the observation information to determine whether the identified variables are redundant may include instructions that when executed cause the at least one processor to generate a second vector containing second feature values of the single feature of the observation information, where the second feature values are a function of the first variable while the second variable has a second fixed value. The instructions that when executed cause the at least one processor to analyze at least the portion of the observation information to determine whether the identified variables are redundant may include instructions that when executed cause the at least one processor to use the first and second vectors to determine whether the first and second variables are redundant. The instructions that when executed cause the at least one processor to analyze at least the portion of the observation information to determine whether the identified variables are redundant may include instructions that when executed cause the at least one processor to determine whether (i) observations based on a range of values for a first variable and a second variable fixed to a first value and (ii) observations based on the range of values for the first variable and the second variable fixed to a second value come from a common probability distribution. The non-transitory machine readable medium may contain instructions that when executed cause the at least one processor to train the AI/ML model using the set of training data, deploy the trained AI/ML model, and/or use the trained AI/ML model to process input data and perform inferencing. The AI/ML model may include a classifier that is trained to classify input data into different classes. The set of training data may include observations over a range of values for at least one of the classes and lacks observations over a range of values for at least one other of the classes.

Other technical features may be readily apparent to one skilled in the art from the following figures, descriptions, and claims.

### BRIEF DESCRIPTION OF THE DRAWINGS

For a more complete understanding of this disclosure, reference is made to the following description, taken in conjunction with the accompanying drawings, in which:

FIG. 1 illustrates an example system supporting reduced training sets for training classifiers or other artificial intelligence/machine learning (AI/ML) models according to this disclosure;

FIG. 2 illustrates an example device supporting reduced training sets for training classifiers or other AI/ML models according to this disclosure;

FIG. 3 illustrates an example relationship between variables that can be used to reduce training sets for training classifiers or other AI/ML models according to this disclosure;

FIG. 4 illustrates an example method for determining whether values of two variables come from the same or substantially the same probability distribution according to this disclosure;

FIGS. 5 through 7 illustrate example relationships between classes that can be used to reduce training sets for training classifiers or other AI/ML models according to this disclosure; and

FIG. 8 illustrates an example method for reducing training sets for training classifiers or other AI/ML models according to this disclosure.

### DETAILED DESCRIPTION

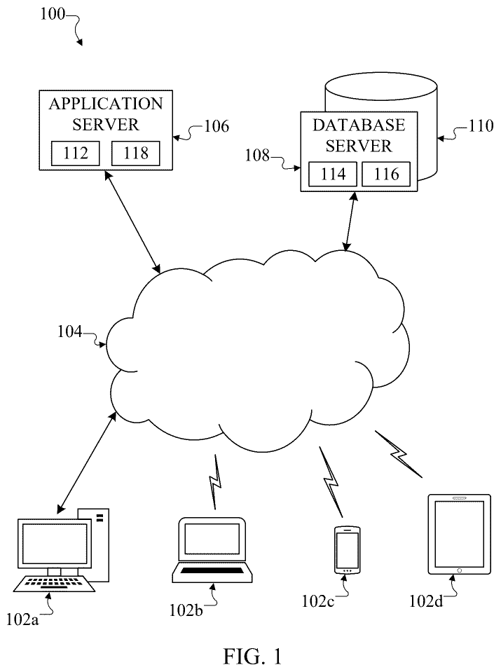

FIGS. 1 through 8, described below, and the various embodiments used to describe the principles of the present disclosure are by way of illustration only and should not be construed in any way to limit the scope of this disclosure. Those skilled in the art will understand that the principles of the present disclosure may be implemented in any type of suitably arranged device or system.

As noted above, modern artificial intelligence/machine learning (AI/ML) models can contain large numbers of parameters, and training modern AI/ML models may require large amounts of training data. For example, some current large language models (LLMs) include more than 175 billion parameters, and these large language models can be trained using training datasets with more than 400 billion tokens. The complexity of AI/ML models will continue to increase over time, and the amount of training data needed for training these AI/ML models will also continue to increase over time.

Even simpler AI/ML models may require relatively large amounts of training data, but training data can be difficult, time-consuming, and expensive to obtain. For example, classifier machine learning models (often referred to simply as “classifiers”) represent machine learning models that are trained to process input data and to classify the input data into specified classes, and the amount of training data needed to train a classifier can be immense even for just a handful of classes. Among other reasons, this can be due to observational variations, meaning there can be a wide variety in the types of observations provided as input data to a classifier for classification. As a particular example, consider a classifier that is trained to classify images of vehicles into different classes associated with the vehicles, such as classes involving different sizes of vehicles or classes involving different types of vehicles. There are various environments in which vehicles can be used and various weather conditions, lighting conditions, and other conditions in which the vehicles can be used. Training a classifier to properly classify images of vehicles may require numerous training images of various types of vehicles in numerous settings.

To alleviate some of the data burden for classifier or other AI/ML model training, investigators may sometimes assume that two variables potentially used by the AI/ML model are independent of one another or are dependent on one another. If two variables are independent, training data generally needs to include data for both variables. If two variables are dependent, training data may be provided for one variable but may not need to be provided (at least to a significant extent) for the other variable. However, investigators often do not actually evaluate these assumptions. Even if investigators try to evaluate their assumptions, past measurements of variables' independence have often been based on determining a mean square error between observations for different settings of the variables, but this is not tuned to account for the specific features used by an AI/ML model and is typically suboptimal. Also, a threshold for the mean square error used to differentiate independence from dependence is generally arbitrary and is not rigorously or statistically defined.

Another way to alleviate some of the data burden for classifier or other AI/ML model training is to initially train the AI/ML model using some training data and look for parameters of the trained AI/ML model having zero or near zero weights, which indicate that those parameters do not contribute in a significant manner to outputs generated by the AI/ML model. Those parameters may be dropped, and the AI/ML model with fewer parameters may be trained. However, this approach still requires obtaining an adequate amount of training data in order to initially train the AI/ML model and is generally more time-consuming.

This disclosure provides techniques for reduced training sets for training classifiers or other AI/ML models. As described in more detail below, observation information related to an AI/ML model to be trained can be obtained, and multiple variables associated with the observation information can be identified. At least a portion of the observation information associated with the identified variables can be analyzed to determine whether the identified variables are redundant. If it is determined that two or more of the identified variables are redundant with one another based on the analysis, a set of training data for training the AI/ML model can be obtained, where the set of training data includes observations over a range of values for at least one of the two or more variables determined to be redundant and lacks observations over a range of values for at least one other of the two or more variables determined to be redundant. In some cases, the AI/ML model can be trained using the set of training data, and the trained AI/ML model can be deployed and/or used to process input data and perform inferencing. Also, in some cases, the AI/ML model may include a classifier that is trained to classify input data into different classes, and the set of training data may include observations over a range of values for at least one of the classes and lacks observations over a range of values for at least one other of the classes.

In this way, the described techniques can be used to reduce the burden of extraordinarily large training datasets and speed up processing times without reducing AI/ML model performance to a significant extent. For example, these techniques may be used to determine if two or more variables are redundant and use that determination to reduce the dimensionality of the training data and to reduce the number of data samples used in training. This can also help to reduce the processing resources needed during training. Moreover, this approach can be used to reduce the amount of redundant training data before an AI/ML model is trained and possibly even before some of the training data is collected.

These techniques may be used with any suitable AI/ML models to be trained. Note what while use with classifier machine learning models is often discussed below, this is for illustration and explanation only. The techniques described in this disclosure may be used with a wide variety of AI/ML models, including AI/ML models now known or later developed.

FIG. 1 illustrates an example system 100 supporting reduced training sets for training classifiers or other AI/ML models according to this disclosure. As shown in FIG. 1, the system 100 includes multiple user devices 102a-102d, at least one network 104, at least one application server 106, and at least one database server 108 associated with at least one database 110. Note, however, that other combinations and arrangements of components may also be used here.

In this example, each user device 102a-102d is coupled to or communicates over the network 104. Communications between each user device 102a-102d and the network 104 may occur in any suitable manner, such as via a wired or wireless connection. Each user device 102a-102d represents any suitable device or system used by at least one user to provide information to the application server 106 or database server 108 or to receive information from the application server 106 or database server 108. Any suitable number(s) and type(s) of user devices 102a-102d may be used in the system 100. In this particular example, the user device 102a represents a desktop computer, the user device 102b represents a laptop computer, the user device 102c represents a smartphone, and the user device 102d represents a tablet computer. However, any other or additional types of user devices may be used in the system 100. Each user device 102a-102d includes any suitable structure configured to transmit and/or receive information.

The network 104 facilitates communication between various components of the system 100, such as via wired or wireless connections. For example, the network 104 may communicate Internet Protocol (IP) packets, frame relay frames, Asynchronous Transfer Mode (ATM) cells, or other suitable information between network addresses. The network 104 may include one or more local area networks (LANs), metropolitan area networks (MANs), wide area networks (WANs), all or a portion of a global network such as the Internet, or any other communication system or systems at one or more locations. The network 104 may also operate according to any appropriate communication protocol or protocols.

The application server 106 is coupled to the network 104 and is coupled to or otherwise communicates with the database server 108. In some cases, the application server 106 supports the execution of at least one application 112 that can determine what training data 114 may need to be used to train one or more AI/ML models 116. For example, the application server 106 may perform the techniques described below to reduce redundancy in the training data 114 used to train the one or more AI/ML models 116. As described below, this can be done based on probability or cumulative distributions of the training data 114, histograms of the training data 114, or other analysis results based on the training data 114. In other cases, the application server 106 supports the execution of at least one application 118, which can use one or more trained AI/ML models 116 to perform one or more functions, such as classifying input data into different classes. In other cases, the application server 106 may support both the application(s) 112 and the application(s) 118.

The database server 108 operates to store and facilitate retrieval of various information used, generated, or collected by the application server 106 and the user devices 102a-102d in the database 110. For example, the database server 108 may store various information in relational database tables or other data structures in the database 110. In some embodiments, the database 110 can be used to store and facilitate retrieval of information used by the application server 106, such as training data 114 and/or one or more trained AI/ML models 116. Note that the database server 108 may also be used within the application server 106 to store information, in which case the application server 106 may store the information itself.

Although FIG. 1 illustrates one example of a system 100 supporting reduced training sets for training classifiers or other AI/ML models, various changes may be made to FIG. 1. For example, the system 100 may include any suitable number of user devices 102a-102d, networks 104, application servers 106, database servers 108, databases 110, applications 112, 118, sets of training data 114, and AI/ML models 116. Also, these components may be located in any suitable locations and might be distributed over a large area. In addition, while FIG. 1 illustrates one example operational environment in which reduced training sets for training classifiers or other AI/ML models may be used, this functionality may be used in any other suitable system.

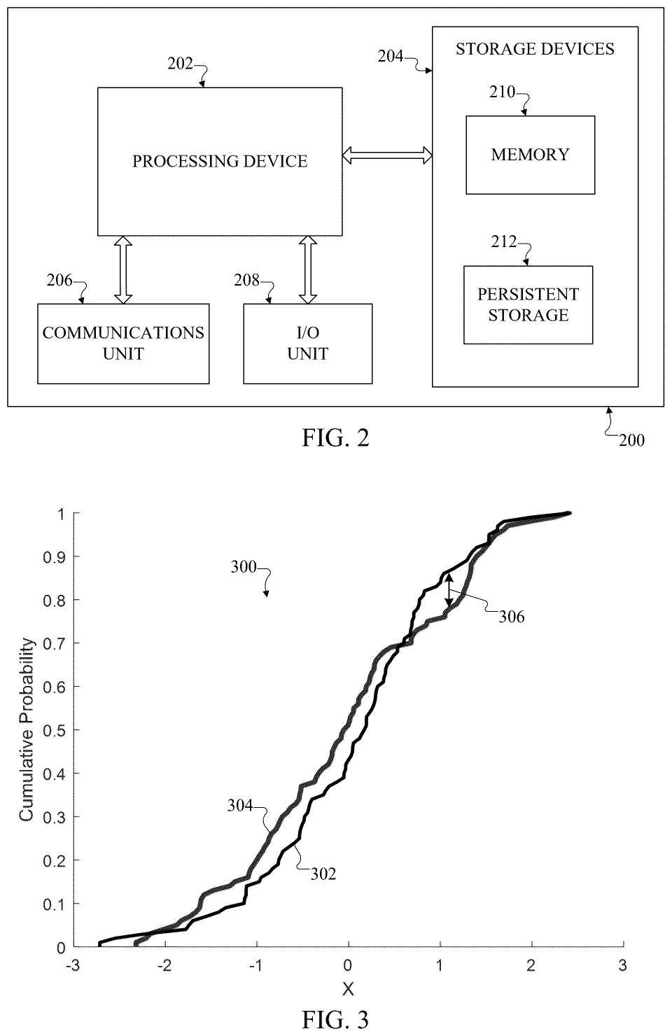

FIG. 2 illustrates an example device 200 supporting reduced training sets for training classifiers or other AI/ML models according to this disclosure. One or more instances of the device 200 may, for example, be used to at least partially implement the functionality of a user device 102a-102d, application server 106, or database server 108 in FIG. 1. However, each of these components may be implemented in any other suitable manner.

As shown in FIG. 2, the device 200 denotes a computing device or system that includes at least one processing device 202, at least one storage device 204, at least one communications unit 206, and at least one input/output (I/O) unit 208. The processing device 202 may execute instructions that can be loaded into a memory 210. The processing device 202 includes any suitable number(s) and type(s) of processors or other processing devices in any suitable arrangement. Example types of processing devices 202 include one or more microprocessors, microcontrollers, digital signal processors (DSPs), application specific integrated circuits (ASICs), field programmable gate arrays (FPGAs), graphics processing units (GPUs), analog processing units (APUs), or discrete circuitry.

The memory 210 and a persistent storage 212 are examples of storage devices 204, which represent any structure(s) capable of storing and facilitating retrieval of information (such as data, program code, and/or other suitable information on a temporary or permanent basis). The memory 210 may represent a random access memory or any other suitable volatile or non-volatile storage device(s). The persistent storage 212 may contain one or more components or devices supporting longer-term storage of data, such as a read only memory, hard drive, Flash memory, or optical disc.

The communications unit 206 supports communications with other systems or devices. For example, the communications unit 206 can include a network interface card or a wireless transceiver facilitating communications over a wired or wireless network. The communications unit 206 may support communications through any suitable physical or wireless communication link(s). As a particular example, the communications unit 206 may support communication over the network(s) 104 of FIG. 1.

The I/O unit 208 allows for input and output of data. For example, the I/O unit 208 may provide a connection for user input through a keyboard, mouse, keypad, touchscreen, or other suitable input device. The I/O unit 208 may also send output to a display or other suitable output device. Note, however, that the I/O unit 208 may be omitted if the device 200 does not require local I/O, such as when the device 200 represents a server or other device that can be accessed remotely.

In some embodiments, instructions can be executed by the processing device 202 in order to implement the functionality of the one or more applications 112 and/or the one or more applications 118. For example, the processing device 202 may execute instructions that cause the processing device 202 to identify redundancies in training data 114 and optionally to train one or more AI/ML models 116 using reduced amounts of training data 114. Also or alternatively, the processing device 202 may execute instructions that cause the processing device 202 to use one or more AI/ML models 116 trained in this manner to perform one or more functions.

Although FIG. 2 illustrates one example of a device 200 supporting reduced training sets for training classifiers or other AI/ML models, various changes may be made to FIG. 2. For example, computing and communication devices and systems come in a wide variety of configurations, and FIG. 2 does not limit this disclosure to any particular computing or communication device or system.

The following now describes example approaches for reducing training datasets for training classifiers or other AI/ML models. It should be noted that while these approaches are described in detail below, other approaches may be used to reduce training datasets for training classifiers or other AI/ML models. For example, while various techniques are described below for identifying redundant training data, other techniques for identifying redundant training data may be used.

In some embodiments, the identification of redundant training data can be based on the idea that a AI/ML model 116 need not be trained using a larger set of training data 114 if the AI/ML model 116 can be adequately trained using a subset of the larger set of training data 114. One example of this can be expressed as follows. Assume there are two potential explanatory variables A and B for an observation O, meaning O is potentially a function of A and B and can therefore be expressed as O(A, B). To properly train a classifier or other AI/ML model 116 to classify or predict O, the training data 114 for the AI/ML model 116 would typically need to include numerous observations O for each setting of both A and B. The following provides a practical approach to determine if A and B are both necessary to explain the observations O before training of the classifier or other AI/ML model 116 occurs. Thus, if it turns out that O does not depend upon B as an underlying variable, the training data 114 used to train the classifier or other AI/ML model 116 may not need to include observations of settings for B in order to adequately train the classifier or other AI/ML model 116. Stated another way, providing training data that includes observations O of all settings for B will not generally improve the accuracy of the resulting trained AI/ML model 116 since correct classes or predictions of O will not be based on B. Instead, the AI/ML model 116 can be adequately trained with training data 114 that includes observations O of settings for A.

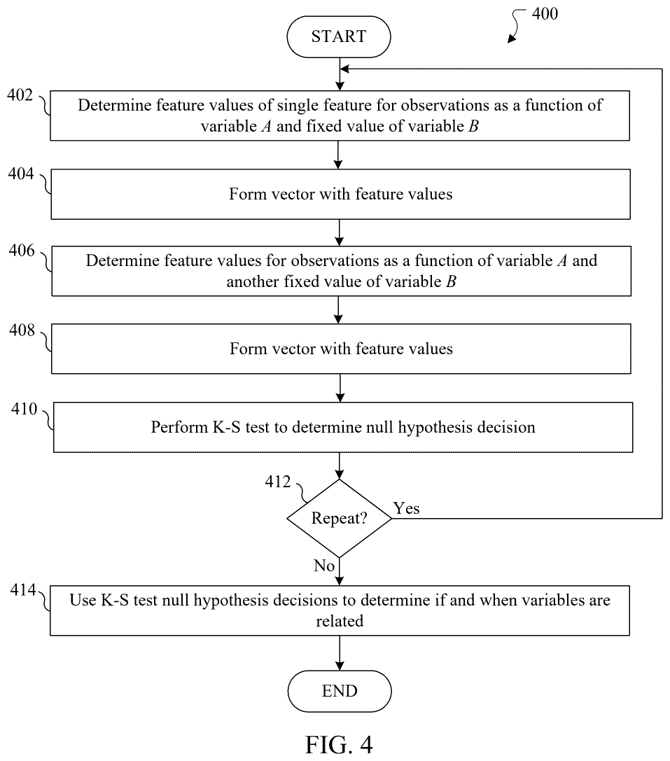

In some cases, this redundancy condition can be determined by comparing observations O based on one setting of a random variable B (while varying settings of a random variable A) to observations O based on another setting of the same random variable B (while varying settings of the random variable A) to determine if both sets of observations O come from the same or substantially similar probability distribution. If so, this is indicative that the observations O only depend upon A and do not depend upon B. FIG. 3 illustrates an example relationship between variables that can be used to reduce training sets for training classifiers or other AI/ML models according to this disclosure. As shown in FIG. 3, a graph 300 includes two lines 302 and 304, which plot the cumulative probabilities of two variables A and B, respectively. A difference or distance 306 can be defined between the lines 302 and 304 and may identify the largest difference between the two cumulative probabilities. If that difference or distance 306 is suitably small, an assumption can be made that the lines 302 and 304 represent two variables A and B coming from the same or substantially the same probability distribution.

One example approach for determining whether two variables A and B come from the same or substantially the same probability distribution is the two-sample Kolmogorov-Smirnov test (also referred to as the “K-S test” below). The two-sample K-S test quantifies a distance between empirical cumulative distribution functions of two samples. The two-sample K-S test can therefore be used to compare observations O from one setting of a random variable B to another setting of the random variable B in order to determine if both sets of observations come from the same probability distribution.

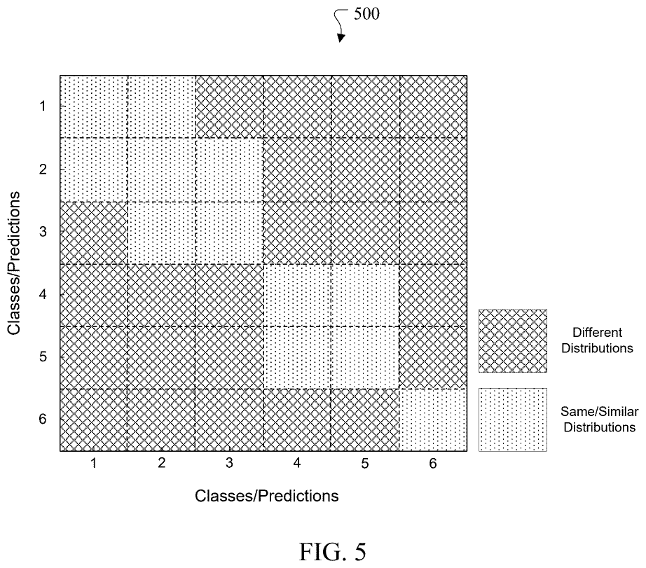

FIG. 4 illustrates an example method 400 for determining whether values of two variables come from the same or substantially the same probability distribution according to this disclosure. For case of explanation, the method 400 shown in FIG. 4 is described as being performed by the application server 106 in the system 100 shown in FIG. 1, where the application server 106 may be implemented using one or more instances of the device 200 shown in FIG. 2. However, the method 400 shown in FIG. 4 may be performed using any other suitable device(s) and with any other suitable process(es) and in any other suitable system(s).

As shown in FIG. 4, feature values of a single feature for observations as a function of a first variable A and a fixed value of variable B are identified at step 402 and formed into a vector at step 404. This may include, for example, the processing device 202 of the application server 106 analyzing training data 114 to identify the feature values of a specific feature, where those feature values can change with respect to the first variable A while the variable B has a first fixed value. As an example of this, assume that training images capture different types of vehicles in different settings. This may include identifying feature values of one feature within the training images (such as a height of the vehicles in the training images) while another variable is fixed to a specific value (such as a specific type of the vehicles in the training images). Thus, for instance, the feature values may identify various vehicle heights for a single first type of vehicle.

Feature values of the same single feature for observations as a function of the first variable A and another (different) fixed value of variable B are identified at step 406 and formed into a vector at step 408. This may include, for example, the processing device 202 of the application server 106 analyzing the training data 114 to identify the feature values of the same specific feature, where those feature values can change with respect to the first variable A while the variable B has a second fixed value. As an example of this, again assume that training images capture different types of vehicles in different settings. This may include identifying feature values of the same feature within the training images (such as a height of the vehicles in the training images) while the other variable is fixed to another specific value (such as another specific type of the vehicles in the training images). Thus, for instance, the feature values may identify various vehicle heights for a single second type of vehicle.

A K-S test is performed using the two vectors to determine a null hypothesis decision at step 410. This may include, for example, the processing device 202 of the application server 106 comparing empirical cumulative distribution functions of first and second samples, where the first samples are represented by the first vector and the second samples are represented by the second vector. The null hypothesis decision indicates whether the empirical cumulative distribution functions of the first and second samples indicate that the first and second samples come from the same or substantially the same probability distribution. As noted above, when the empirical cumulative distribution functions indicate that the first and second samples come from the same or substantially the same probability distribution, the two variables A and B may be viewed as being redundant at least with respect to the single feature.

A determination is made whether to repeat this process at step 412. This may include, for example, the processing device 202 of the application server 106 determining whether feature values for all features have been tested. If not, the process returns to step 402, and steps 402-410 may be repeated based on feature values of a different single feature for the observations. Otherwise, the null hypothesis decisions of the K-S tests can be used to identify if and when the two variables are related or dependent at step 414. This may include, for example, the processing device 202 of the application server 106 generating a heat map of the K-S test null hypothesis decisions. As described below, the heat map may graphically illustrate how different features of the observations may relate to one another.

As a more detailed explanation of this approach, consider the following. Assume that a multi-dimensional observation vector O has observations denoted Oⱼ in its j dimensions. Given this notation, if P(Oⱼ|A, B=B₁)=P(Oⱼ|A, B=B₂)= . . . =P(Oⱼ|A, B=Bᵢ) ∀i, it can be shown that P(Oⱼ|A, B=Bᵢ)=P(Oⱼ|A). In other words, if this expression is satisfied, the observations Oⱼ are independent of the value of the variable B given the variable A. This explains why two variables coming from the same probability distribution could be repetitive or redundant in terms of training data related to those two variables. More specifically, this allows for a reduction in training data by training across values of one variable but not training across values of the other variable.

Whether this condition is satisfied for two random variables A and B can be tested using the two-sample K-S test. For example, a two-sample Kolmogorov-Smirnov statistic may be determined for the two random variables A and B as follows.

$${D}_{n , m} = \begin{matrix}sup \\ x\end{matrix} \vert {\hat{F}}_{1 , n} ( x ) - {\hat{F}}_{2 , m} ( x ) \vert$$

Here, \hat{F}_{1,n}(x) and \hat{F}_{2,m}(x) represent the empirical cumulative distribution functions of the first and second samples, respectively. Also, sup represents the supremum function, and D_{n,m} represents the value of the two-sample Kolmogorov-Smirnov statistic. Given an adequately-large number of samples, the null hypothesis can be rejected at a level a if the following condition is satisfied.

$${D}_{n , m} > \sqrt{- ln ( \frac{∝}{2} ) \cdot \frac{1 + \frac{m}{n}}{2 m}}$$

Thus, when the two-sample Kolmogorov-Smirnov statistic D_{n,m} is greater than this threshold value, the null hypothesis decision can be negative, meaning the samples are not from the same or substantially the same probability distribution. When the two-sample Kolmogorov-Smirnov statistic D_{n,m} is less than this threshold value, the null hypothesis decision can be positive, meaning the samples are from the same or substantially the same probability distribution.

This approach therefore returns a null hypothesis decision whether data in the two vectors are from the same or substantially the same continuous probability distribution, which would mean that the observations Oⱼ are essentially the same for each setting of the variable B. The K-S test is non-parametric, so it is not necessary to fit (derive) sufficient statistics to describe the distributions. Moreover, performing the K-S test for values in a feature space may allow the K-S test to more accurately compare features meaningful to classification or other AI/ML algorithms.

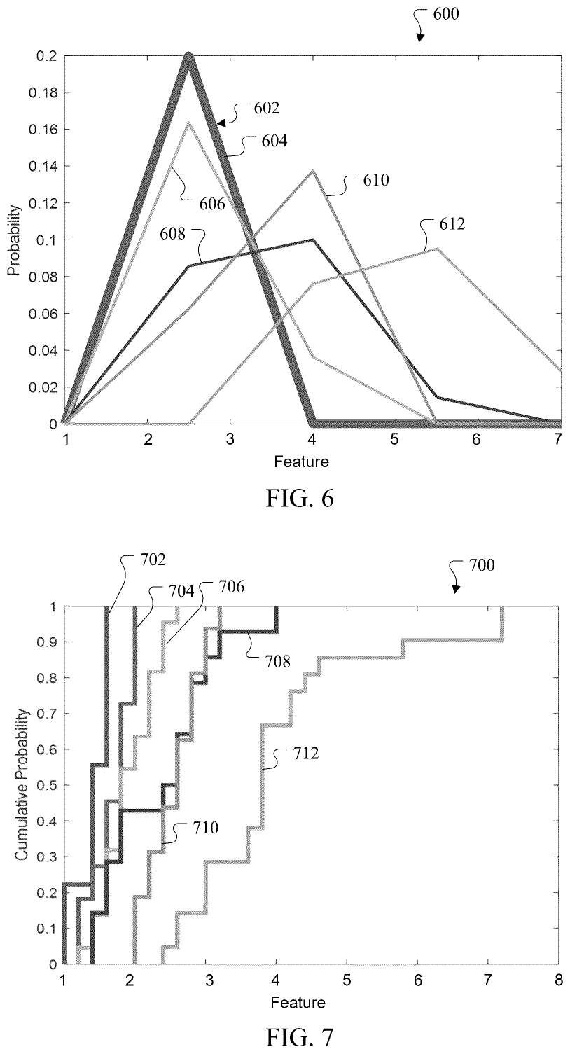

FIGS. 5 through 7 illustrate example relationships between classes that can be used to reduce training sets for training classifiers or other AI/ML models according to this disclosure. More specifically, FIGS. 5 through 7 illustrate example results that may be obtained using the K-S test or other suitable test to determine whether samples of variables are from the same or substantially the same probability distribution.

As shown in FIG. 5, an example heat map 500 is provided and identifies results associated with six different classes or predictions that may be generated by a classifier or other AI/ML model. The intersection of a class/prediction from the horizontal axis and a class/prediction from the vertical axis indicates whether those two classes/predictions are identified as being from the same or substantially the same probability distribution. All entries along the diagonal from the top left to bottom right indicate that the classes/predictions are from the same or substantially the same probability distribution, which is expected since the diagonal entries are comparing the same samples for the same classes. However, the heat map 500 in this example also indicates that class/prediction #1 and class/prediction #2 are from the same or substantially the same probability distribution, class/prediction #2 and class/prediction #3 are from the same or substantially the same probability distribution, and class/prediction #4 and class/prediction #5 are from the same or substantially the same probability distribution. In some embodiments, these determinations can be made by performing the method 400 as described above.

FIG. 6 illustrates an example graph 600 that includes lines 602-612, which respectively plot the empirical probability distribution functions of the six classes/predictions from FIG. 5. FIG. 7 illustrates an example graph 700 that includes lines 702-712, which respectively plot the empirical cumulative distribution functions of the six classes/predictions from FIG. 5. As can be seen in FIG. 6, lines 602 and 604 essentially overlap, indicating that class/prediction #1 and class/prediction #2 are from the same or substantially the same probability distribution. As can be seen in FIG. 7, lines 702 and 704 are similar, indicating class/prediction #1 and class/prediction #2 are from the same or substantially the same probability distribution. Also, lines 704 and 706 are similar, indicating class/prediction #2 and class/prediction #3 are from the same or substantially the same probability distribution. In addition, lines 708 and 710 are similar, indicating class/prediction #4 and class/prediction #5 are from the same or substantially the same probability distribution. Thus, by using the empirical probability distribution functions and empirical cumulative distribution functions, it is possible to identify which classes/predictions are related.

From this, it is possible to prune the training data 114 needed a train the classifier or other AI/ML model, since training data for one class/prediction can be redundant to training data for a related class/prediction. For example, training data 114 in this example may only need to be provided for class/prediction #1 or #2 (but not both), class/prediction #2 or #3 (but not both), and class/prediction #4 or #5 (but not both). Ideally, this can reduce the burden of obtaining suitable training data and reduce the amount of time needed to train the associated AI/ML model 116. In some cases, this can also help to speed up processing times when using the trained AI/ML model 116, since the trained AI/ML model 116 may have less complexity (such as fewer dimensions) and require fewer data samples without reducing model performance to a significant extent.

Note that the K-S test represents above one approach for determining whether values of two variables are from the same or substantially the same probability distribution. The specific example of the K-S test above is a one-dimensional approach in which the difference is along a single axis (two variables). However, it is possible to extend this approach to use with more than two variables, in which case there can be multiple differences in multiple dimensions. Any suitable technique could be used to identify one or more thresholds that are applied to the multiple differences in order to determine whether the multiple variables are related to one another. As a particular example of an approach for comparing multi-dimensional probability or cumulative distributions, the Dvoretzky-Kiefer-Wolfowitz (DKW) inequality can be used to generalize the K-S test to determine if the cumulative distribution functions of multiple random variables are the same or substantially the same. The DKW inequality generally states that, for any sequence of independent and identically distributed k-dimensional random variables θ (where k>1), the following can be obtained for all t≥0 with a sufficiently large number of samples n.

$$Pr ( \begin{matrix}sup \\ θ ∈ {ℝ}^{k}\end{matrix} \vert {F}_{n} ( θ ) - F ( θ ) \vert > t ) \leq 2 k {e}^{- 2 {nt}^{2}}$$

If this inequality is violated, the null hypothesis can be rejected at level t.

Moreover, other tests or approaches may be used to make this determination. For example, histograms may be generated for different features associated with training data 114, and differences between the histograms for different features can be determined. The maximum difference or a combination of differences (such as their average) can be compared to a threshold, and a determination can be made that the histograms are associated with related features when the threshold is not exceeded. Again, this could be performed between two variables or more than two variables, and one or more suitable thresholds may be identified and used to determine whether the two or more two variables are related to one another. As another example, it may be possible to perform singular value decomposition (SVD), principal component analysis (PCA), or other analysis to reduce the dimensionality of the training data 114 by removing less useful dimensions and retaining the more useful dimensions of the training data 114.

Although FIG. 3 illustrates one example of a relationship between variables that can be used to reduce training sets for training classifiers or other AI/ML models, various changes may be made to FIG. 3. For example, two variables may be related in any other suitable manner depending on the circumstances. Although FIG. 4 illustrates one example of a method 400 for determining whether values of two variables come from the same or substantially the same probability distribution, various changes may be made to FIG. 4. For instance, while shown as a series of steps, various steps in FIG. 4 may overlap, occur in parallel, occur in a different order, or occur any number of times. Although FIGS. 5 through 7 illustrate examples of relationships between classes that can be used to reduce training sets for training classifiers or other AI/ML models, various changes may be made to FIGS. 5 through 7. As examples, a heat map or other results may be generated for any suitable number of features, and the specific relationships shown here are merely meant to help illustrate various teachings of this disclosure.

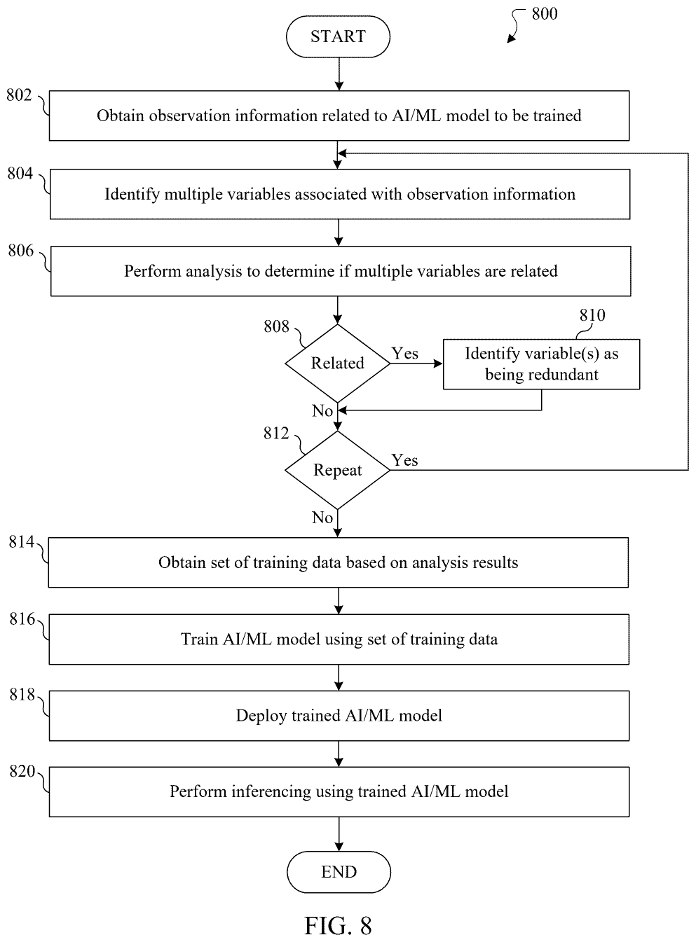

FIG. 8 illustrates an example method 800 for reducing training sets for training classifiers or other AI/ML models according to this disclosure. For case of explanation, the method 800 shown in FIG. 8 is described as being performed by the application server 106 in the system 100 shown in FIG. 1, where the application server 106 may be implemented using one or more instances of the device 200 shown in FIG. 2. However, the method 800 shown in FIG. 8 may be performed using any other suitable device(s) and with any other suitable process(es) and in any other suitable system(s).

As shown in FIG. 8, observation information related to an AI/ML model to be trained is obtained at step 802. This may include, for example, the processing device 202 of the application server 106 obtaining training data 114 or other data identifying observations O and related data. The observation information here can be obtained from any suitable source(s) and in any suitable manner. The observation information may represent training data 114 that has already been obtained or information generally associated with observations O to be processed using a AI/ML model 116.

Two or more variables associated with the observation information are identified at step 804. This may include, for example, the processing device 202 of the application server 106 identifying two or more variables whose values vary within the observation information. Note that the variables here may be identified in any suitable manner, such as based on user input or in an automated manner. At least one analysis is performed to determine whether the variables are related at step 806, and a determination is made whether the selected variables are related based on the at least one analysis at step 808. This may include, for example, the processing device 202 of the application server 106 performing the two-sample K-S test as shown in FIG. 4 and described above to determine whether values of the selected variables come from the same or substantially the same probability distribution. As noted above, however, one or more other or additional analyses may be performed to determine whether the selected variables are related. This may also include the processing device 202 of the application server 106 determining whether a K-S statistic or other value generated during the at least one analysis exceeds a specified threshold. In some cases, the specified threshold can be determined algorithmically so that the specified threshold is not simply assigned in an arbitrary manner. If the selected variables are determined to be related, at least one of the selected variables can be identified as being redundant at step 810.

A determination is made whether to repeat the processing of another set of variables at step 812. This may include, for example, the processing device 202 of the application server 106 determining whether there is at least one combination of variables that has not been analyzed. If so, the process returns to step 804 to select and analyze another combination of variables. Otherwise, at least one set of training data can be obtained based on the analysis results at step 814. This may include, for example, the processing device 202 of the application server 106 obtaining training data 114 for variables that have been identified as not being redundant to one another. In some cases, the obtained training data 114 may be extracted from a larger set of training data 114 that is already available. In other cases, the identification of which variables are or are not redundant can be used to identify what training data 114 needs to be obtained, and that training data 114 can be generated or collected. In general, this disclosure is not limited to any specific technique or techniques for obtaining training data 114 that is not redundant.

An AI/ML model is trained using the obtained training data at step 816. This may include, for example, the processing device 202 of the application server 106 training a classifier or other AI/ML model 116 to generate classes or predictions based on the obtained training data 114. Note that any of a wide variety of AI/ML model architectures and AI/ML model training processes may be used here. Once adequately trained, the trained AI/ML model may be deployed at step 818. This may include, for example, the processing device 202 of the application server 106 providing the trained AI/ML model 116 to one or more other devices for use or placing the trained AI/ML model 116 into use by the application server 106. The trained AI/ML model can be used to perform inferencing at step 820. This may include, for example, the processing device 202 of the application server 106 or another device providing input data to the trained AI/ML model 116 and generating classes or predictions based on the input data.

Although FIG. 8 illustrates one example of a method 800 for reducing training sets for training classifiers or other AI/ML models, various changes may be made to FIG. 8. For example, while shown as a series of steps, various steps in FIG. 8 may overlap, occur in parallel, occur in a different order, or occur any number of times. Also, it is possible for different devices to perform various steps in FIG. 8, such as when one device performs steps 802-814, another device performs steps 816-818, and yet another device performs step 820. In general, a single device or any number of devices may be used to perform the various steps in FIG. 8.

In some embodiments, various functions described in this patent document are implemented or supported by a computer program that is formed from computer readable program code and that is embodied in a computer readable medium. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

It may be advantageous to set forth definitions of certain words and phrases used throughout this patent document. The terms “application” and “program” refer to one or more computer programs, software components, sets of instructions, procedures, functions, objects, classes, instances, related data, or a portion thereof adapted for implementation in a suitable computer code (including source code, object code, or executable code). The term “communicate”, as well as derivatives thereof, encompasses both direct and indirect communication. The terms “include” and “comprise”, as well as derivatives thereof, mean inclusion without limitation. The term “or” is inclusive, meaning and/or. The phrase “associated with,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, have a relationship to or with, or the like. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

The description in the present disclosure should not be read as implying that any particular element, step, or function is an essential or critical element that must be included in the claim scope. The scope of patented subject matter is defined only by the allowed claims. Moreover, none of the claims invokes 35 U.S.C. § 112(f) with respect to any of the appended claims or claim elements unless the exact words “means for” or “step for” are explicitly used in the particular claim, followed by a participle phrase identifying a function. Use of terms such as (but not limited to) “mechanism”, “module”, “device”, “unit”, “component”, “element”, “member”, “apparatus”, “machine”, “system”, “processor”, or “controller” within a claim is understood and intended to refer to structures known to those skilled in the relevant art, as further modified or enhanced by the features of the claims themselves, and is not intended to invoke 35 U.S.C. § 112(f).

While this disclosure has described certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure, as defined by the following claims.

What is claimed is:

1. A method comprising:
obtaining observation information related to an artificial intelligence/machine learning (AI/ML) model to be trained;
identifying multiple variables associated with the observation information;
analyzing at least a portion of the observation information associated with the identified variables to determine whether the identified variables are redundant;
determining that two or more of the identified variables are redundant with one another based on the analysis; and
obtaining a set of training data for training the AI/ML model, wherein the set of training data includes observations over a range of values for at least one of the two or more variables determined to be redundant and lacks observations over a range of values for at least one other of the two or more variables determined to be redundant.

2. The method of claim 1, wherein:
analyzing at least the portion of the observation information to determine whether the identified variables are redundant comprises performing a two-sample Kolmogorov-Smirnov test to determine whether the identified variables are redundant; and
determining that the two or more variables are redundant with one another comprises determining that a Kolmogorov-Smirnov statistic generated during the two-sample Kolmogorov-Smirnov test does not meet or exceed a threshold value.

3. The method of claim 1, wherein analyzing at least the portion of the observation information to determine whether the identified variables are redundant comprises:
generating a first vector containing first feature values of a single feature of the observation information, the first feature values being a function of a first variable of the multiple variables while a second variable of the multiple variables has a first fixed value;
generating a second vector containing second feature values of the single feature of the observation information, the second feature values being a function of the first variable while the second variable has a second fixed value; and
using the first and second vectors to determine whether the first and second variables are redundant.

4. The method of claim 1, wherein analyzing at least the portion of the observation information to determine whether the identified variables are redundant comprises determining whether (i) observations based on a range of values for a first variable and a second variable fixed to a first value and (ii) observations based on the range of values for the first variable and the second variable fixed to a second value come from a common probability distribution.

5. The method of claim 1, further comprising:
training the AI/ML model using the set of training data.

6. The method of claim 5, wherein:
the AI/ML model comprises a classifier that is trained to classify input data into different classes; and
the set of training data comprises observations over a range of values for at least one of the classes and lacks observations over a range of values for at least one other of the classes.

7. The method of claim 5, further comprising at least one of:
deploying the trained AI/ML model; or
using the trained AI/ML model to process input data and perform inferencing.

8. An apparatus comprising:
at least one processing device configured to:
obtain observation information related to an artificial intelligence/machine learning (AI/ML) model to be trained;
identify multiple variables associated with the observation information;
analyze at least a portion of the observation information associated with the identified variables to determine whether the identified variables are redundant;
determine that two or more of the identified variables are redundant with one another based on the analysis; and
obtain a set of training data for training the AI/ML model, wherein the set of training data includes observations over a range of values for at least one of the two or more variables determined to be redundant and lacks observations over a range of values for at least one other of the two or more variables determined to be redundant.

9. The apparatus of claim 8, wherein:
the at least one processing device is configured to perform a two-sample Kolmogorov-Smirnov test to determine whether the identified variables are redundant; and
the at least one processing device is configured to determine that a Kolmogorov-Smirnov statistic generated during the two-sample Kolmogorov-Smirnov test does not meet or exceed a threshold value to determine that the two or more variables are redundant with one another.

10. The apparatus of claim 8, wherein, to analyze at least the portion of the observation information to determine whether the identified variables are redundant, the at least one processing device is configured to:
generate a first vector containing first feature values of a single feature of the observation information, the first feature values being a function of a first variable of the multiple variables while a second variable of the multiple variables has a first fixed value;
generate a second vector containing second feature values of the single feature of the observation information, the second feature values being a function of the first variable while the second variable has a second fixed value; and
use the first and second vectors to determine whether the first and second variables are redundant.

11. The apparatus of claim 8, wherein, to analyze at least the portion of the observation information to determine whether the identified variables are redundant, the at least one processing device is configured to determine whether (i) observations based on a range of values for a first variable and a second variable fixed to a first value and (ii) observations based on the range of values for the first variable and the second variable fixed to a second value come from a common probability distribution.

12. The apparatus of claim 8, wherein the at least one processing device is further configured to train the AI/ML model using the set of training data.

13. The apparatus of claim 12, wherein:
the AI/ML model comprises a classifier that is trained to classify input data into different classes; and
the set of training data comprises observations over a range of values for at least one of the classes and lacks observations over a range of values for at least one other of the classes.

14. The apparatus of claim 12, wherein the at least one processing device is further configured to at least one of:
deploy the trained AI/ML model; or
use the trained AI/ML model to process input data and perform inferencing.

15. A non-transitory machine readable medium containing instructions that when executed cause at least one processor to:
obtain observation information related to an artificial intelligence/machine learning (AI/ML) model to be trained;
identify multiple variables associated with the observation information;
analyze at least a portion of the observation information associated with the identified variables to determine whether the identified variables are redundant;
determine that two or more of the identified variables are redundant with one another based on the analysis; and
obtain a set of training data for training the AI/ML model, wherein the set of training data includes observations over a range of values for at least one of the two or more variables determined to be redundant and lacks observations over a range of values for at least one other of the two or more variables determined to be redundant.

16. The non-transitory machine readable medium of claim 15, wherein:
the instructions that when executed cause the at least one processor to analyze at least the portion of the observation information to determine whether the identified variables are redundant comprises:
instructions that when executed cause the at least one processor to perform a two-sample Kolmogorov-Smirnov test to determine whether the identified variables are redundant; and
the instructions that when executed cause the at least one processor to determine that the two or more variables are redundant with one another comprise:
instructions that when executed cause the at least one processor to determine that a Kolmogorov-Smirnov statistic generated during the two-sample Kolmogorov-Smirnov test does not meet or exceed a threshold value.

17. The non-transitory machine readable medium of claim 15, wherein the instructions that when executed cause the at least one processor to analyze at least the portion of the observation information to determine whether the identified variables are redundant comprise:
instructions that when executed cause the at least one processor to:
generate a first vector containing first feature values of a single feature of the observation information, the first feature values being a function of a first variable of the multiple variables while a second variable of the multiple variables has a first fixed value;
generate a second vector containing second feature values of the single feature of the observation information, the second feature values being a function of the first variable while the second variable has a second fixed value; and
use the first and second vectors to determine whether the first and second variables are redundant.

18. The non-transitory machine readable medium of claim 15, wherein the instructions that when executed cause the at least one processor to analyze at least the portion of the observation information to determine whether the identified variables are redundant comprise:
instructions that when executed cause the at least one processor to determine whether (i) observations based on a range of values for a first variable and a second variable fixed to a first value and (ii) observations based on the range of values for the first variable and the second variable fixed to a second value come from a common probability distribution.

19. The non-transitory machine readable medium of claim 15, further containing instructions that when executed cause the at least one processor to at least one of:
train the AI/ML model using the set of training data;
deploy the trained AI/ML model; or
use the trained AI/ML model to process input data and perform inferencing.

20. The non-transitory machine readable medium of claim 19, wherein:
the AI/ML model comprises a classifier that is trained to classify input data into different classes; and
the set of training data comprises observations over a range of values for at least one of the classes and lacks observations over a range of values for at least one other of the classes.
